(19) United States
(12) Patent Application Publication
(10) Pub. No.: US 2006/0031747 A1
(43) Pub. Date: Feb. 9, 2006

(54) Input/output screen creating system, input/output screen creating method, and work processing system

(75) Inventors: Shigefumi Wada, Tokyo (JP); Shigeru Nakayama, Tokyo (JP); Shigekazu Kurozu, Tokyo (JP); Takeshi Haramoto, Tokyo (JP); Takahiro Suzuki, Tokyo (JP); Tatsuhito Ryu, Tokyo (JP); Kazufumi Naito, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: OBIC BUSINESS CONSULTANTS CO., LTD.

(21) Appl. No.: 11/022,865

(22) Filed: Dec. 28, 2004

(30) Foreign Application Priority Data
Aug. 5, 2004 (JP) 2004-229121

(51) Int. Cl. G06F 17/24

(52) U.S. Cl. 715/500; 715/506; 715/530

(57) ABSTRACT

An input/output screen creating system, which creates an input/output screen to be used in a work processing system, has an object storage unit, an input/output screen creating unit, a grid display unit, and an input/output screen storage unit. The object storage unit stores a plurality of objects capable of being arranged on the input/output screen therein. The input/output screen creating unit displays a form for creating and editing the input/output screen, and accepts an input of an arrangement of the objects stored in the object on the form. The grid display unit superposes and arranges grids having the size for a two-byte or one-byte character on a canvas to be a job area on the input/output screen provided to the form. The input/output screen storage unit stores the input/output screen having the objects arranged with them being related with the grids therein.

### BACKGROUND OF THE INVENTION

1. Field of the Invention

The present invention relates to an input/output screen creating system and an input/output screen creating method which are capable of creating an input/output screen for data input or the like to be used in a so-called work processing system, and a work processing system having the input/output screen created by them.

2. Description of the Related Art

In enterprises (includes not only business corporations and private limited companies but also various companies), various so-called work processing systems are used in order to run their jobs. The work processing systems include a financial accounting system, a payroll calculating system, a sales management system, a purchase management system, a stock management system, a tax filing system, a capital assets management system, a cost control system, a client management system, a human resource management system, an electronic banking system, an expense payment system, a travel and transportation expense calculating system, a bill management system, a picking system (the system that extracts specified goods from racks in a store room), a purchase orders management system, a credit reconcilement system, a budget management system, a cash schedule management system, an in-company application system, an attendance management system, a consolidated accounting system, a supplies management system, a credit and debt management system, and the like.

These work processing systems input various information about business activities such as information about financial accounting, information about payroll calculation, information about sales management, information about purchase management, information about stock management, information about tax filing, information about capital assets management, information about cost control, information about client management, information about human resource management, information about electronic banking, information about expense payment, information about travel and transportation expense calculation, information about bill management, information about picking, information about purchase order management, information about credit reconcilement, information about budget management, information about cash schedule management, information about in-company application, information about attendance management, information about consolidated accounting, information about supplies management, information about credit and debt management, and the like thereinto. For this reason, a lot of input/output screens on which information is input and output are prepared in these work processing systems.

When such an input/output screen is created, a programmer conventionally creates input areas (test boxes) and the like in such a manner that their sizes are aligned on an input/output screen one by one. Such a creating method, however, puts a heavier strain on the programmer as the number of screens to be created increases.

Like the invention disclosed in Japanese Patent Application Laid-Open (JP-A) No. 2002-258909, when an input/output screen is created, squares (hereinafter, grids) in horizontal and vertical positions are provided on the input/output screen, and the grids are related with positions of objects on the input/output screen such as input areas (indicating elements displayed on the input/output screen such as display areas and pull-down menus). As a result, even if the size of the objects is changed according to the grids, the input/output screen can be created with the positional relationship of the objects being arranged appropriately.

The invention disclosed in the above JP-A 2002-258909 enables a programmer to manually change a size of virtual parts (objects) according to the grids, thereby making the creation of an input/output screen easy. Objects (virtual parts) to be displayed by the method in JP-A2002-258909 relate to the creation of virtual parts (objects) of a human machine interface (HMI) to be used for monitoring of FA devices and the like.

On the other hand, in the field of the work processing systems, differently from display of the virtual parts of HMI to be used in the FA devices, it is essential to input data. That is to say, in the invention disclosed in JP-A 2002-258909, an input/output screen can be created with the size of the input area being determined according to the grids. When, however, characters with sizes larger than the input area are input, all the characters or the like input into the input area cannot be displayed.

### SUMMARY OF THE INVENTION

The inventors have devised an input/output screen creating system and an input/output screen creating method in which positions of objects displayed on an input/output screen are related with grids provided onto the input/output screen in advance, and one grid is set as the size of one character (one-byte or two-byte character), so that when a user of a work processing system inputs data on the input/output screen, the user can easily change the size of the input area according to the number of characters and the size of characters (font size), and a work processing system having the input/output screen created by them.

The invention according to Claim 1 is an input/output screen creating system that creates an input/output screen to be used in a work processing system, including: an object storage unit that stores a plurality of objects capable of being arranged on the input/output screen; an input/output screen creating unit that displays a form for creating and editing the input/output screen and accepts an input for arranging the objects stored in the object storage unit on the form; a grid display unit that superposes and arranges grids having the size for a two-byte or one-byte character on a canvas to be a job area of the input/output screen provided on the form; and an input/output screen storage unit that stores the input/output screen having the objects related with the grids and arranged.

The invention according to Claim 4 is an input/output screen creating method of creating an input/output screen to be used in a work processing system on a computer terminal, including: the step of displaying a form for creating and editing the input/output screen on a display device of the computer terminal; the step of arranging a canvas to be a job area of the input/output screen on the form; the step of superposing and arranging grids having the size for a two-byte or one-byte character on the canvas; and the step of arranging objects to be arranged on the input/output screen with them being related with coordinates of the grids.

The invention according to Claim 5 is an input/output screen creating method of creating an input/output screen to be used in a work processing system on a computer terminal, including: the step of simultaneously displaying a form for creating and editing the input/output screen and a canvas as a job area of the input/output screen on a display device of the computer terminal so that they have the same size; the step of superposing and arranging grids having the size for a two-byte or one-byte character on the canvas; and the step of arranging objects on the input/output screen with them being related with coordinates of the grids.

The invention according to Claim 6 is an input/output screen creating method of creating an input/output screen to be used in a work processing system on a computer terminal, including: the step of displaying a form for creating and editing the input/output screen as a canvas to be a job area of the input/output screen on a display device of the computer terminal; the step of superposing and arranging grids having the size for a two-byte or one-byte character on the canvas; and the step of arranging objects on the input/output screen with them being related with coordinates of the grids.

According to these inventions, the objects to be arranged on the input/output screen can be created as the input/output screen with them being related with the grids having the size for one character. Further, since the input/output screen can be created so that the grids are related with the input area, the input/output screen with high quality can be created for a shorter time than the conventional time.

The invention according to Claim 2 is the input/output screen creating system in which the input/output screen creating unit accepts an input of a rectangular area as a unit having an arbitrary size capable of according with the size of the objects, and accepts an input of the arrangement of the objects on the canvas in a term of unit.

The invention according to Claim 7 is the input/output screen creating method further including the step of setting a rectangular area having an arbitrary size capable of according with the size of the object as a unit after arranging the superposing and arranging the grids on the canvas.

The units are provided in such a manner, so that the objects to be arranged on the input/output screen can be limited. As a result, the input/output screen can be created based on a constant standard.

The invention according to Claim 3 is the input/output screen creating system in which the work processing system is any one or more of a financial accounting system, a payroll calculating system, a sales management system, a purchase management system, a stock management system, a tax filing system, a capital assets management system, a cost control system, a client management system, a human resource management system, an electronic banking system, an expense payment system, a travel and transportation expense calculating system, a bill management system, a picking system, a purchase orders management system, a credit reconcilement system, a budget management system, a cash schedule management system, an in-company application system, an attendance management system, a consolidated accounting system, a supplies management system, and a credit and debt management system.

The work processing system includes the above systems.

The invention according to Claim 8 is a work processing system having an input/output screen on which an object is arranged with it being related with grids having the size for a two-byte or one-byte character, including: a work process executing unit that executes the process of the work processing system and displays the input/output screen; and an input/output screen editing unit that changes the size of an input area according to the number or a size of characters input into the object in the input area on the input/output screen.

The invention according to Claim 16 is a work processing program that is executed on a computer terminal having a storage unit which stores data therein and a process arithmetic unit which executes the process of the program, including: data about an input/output screen read into the storage unit; a work process executing function that is read into the process arithmetic unit; and an input/output screen editing unit that is read into the process arithmetic unit, wherein the data about the input/output screen are objects which are arranged on the input/output screen so as to be related with grids having the size for a two-byte or one-byte character, the work process executing function displays the input/output screen on the computer terminal based on the data bout the input/output screen stored in the storage unit and executes the work process, the input/output screen editing function changes the size of the input area according to the number or the size of characters input into the object in the input area on the input/output screen.

When these inventions are constituted, if characters or the like are input onto the input/output screen, the size of the input area can be changed accordingly.

The invention according to Claim 9 is the work processing system wherein the input/output screen editing unit calculates a number of characters capable of being input into the input area based on the grids, compares the number of characters capable of being input with a number of characters accepted by the work process executing unit, and when the number of input characters exceeds a predetermined number of characters, enlarges and displays the input area.

The invention according to Claim 17 is the work processing program wherein the input/output screen editing function calculates the number of characters capable of being input into the input area based on the grids, compares the number of characters capable of being input with the number of characters input by the work process executing function, and when the number of the input characters exceeds a predetermined number of characters, enlarges and displays the input area on the computer terminal.

The size of the input area can be changed in a manner like the present invention. That is to say, since the position of the input area is related with the grids having the size for one character, the number of characters capable of being input can be obtained. When the number of characters exceeds the number of characters capable of being input, therefore, the input area is widened accordingly. As a result, all the input characters can be displayed without scrolling the input characters.

The invention according to Claim 10 is the work processing system wherein the input/output screen editing unit changes the coordinates of the grid related with the input area so as to enlarge and display the input area.

The invention according to Claim 11 is the work processing system wherein the input/output screen editing unit changes the size of the grids in the input area so as to enlarge and display the input area.

The invention according to Claim 18 is the work processing program wherein the input/output screen editing function changes coordinates of the grids related with the input area so as to enlarge and display the input area.

The invention according to Claim 19 is the work processing program wherein the input/output screen editing function changes the size of the grids in the input area so as to enlarge and display the input area.

When the input area is widened, the coordinate of the grid of the object in the input area may be changed as mentioned above, or the coordinate is not changed and the size of the grid may be enlarged.

The invention according to Claim 12 is the work processing system wherein the input/output screen editing unit accepts an instruction for a change in the size of characters to be displayed on the input/output screen and changes the size of the grids so as to change sizes of characters and the object to be displayed on the input/output screen.

The invention according to Claim 20 is the work processing program wherein the input/output screen editing function accepts an instruction for a change in the size of characters to be displayed on the input/output screen, and changes the size of the grids so as to change sizes of characters and objects to be displayed on the input/output screen.

When the size of characters to be displayed on the input/output screen is changed, the size of the object is not changed conventionally, and only the size of characters is changed. The characters, therefore, partially chip off and are displayed on the object. Since the size of the grids related with the size of characters is changed by using the above inventions, the size of the object related with the grids is changed accordingly. For this reason, characters to be displayed on the object do not partially chip off unlike a conventional technique.

The invention according to Claim 13 is the work processing system wherein the input/output screen editing unit accepts an instruction for a change in the size of the canvas and changes the size of the grids in the canvas so as to enlarge and display the input area.

The invention according to Claim 14 is the work processing system wherein the input/output screen editing unit accepts the instruction for the change in the size of the canvas, changes a vertical size and/or a lateral size of an arbitrary grid in the canvas cooperatively with the instruction for the change in a vertical and/or a lateral size of the canvas so as to enlarge and display the input area.

The invention according to Claim 15 is the work processing system wherein the input/output screen editing unit accepts the instruction for the change in the size of the canvas, and enlarges the grids in the canvas at the same magnification as that of the size of the canvas to be changed so as to enlarge and display the input area.

The invention according to Claim 21 is the work processing program wherein the input/output screen editing function accepts an instruction for a change in the size of the canvas, and changes the size of the grids in the canvas so as to enlarge and display the input area.

The invention according to Claim 22 is the work processing program wherein the input/output screen editing function accepts the instruction for the change in the size of the canvas, and changes a vertical size and/or a lateral size of an arbitrary grid in the canvas cooperatively with the instruction for the change in a vertical size and/or a lateral size of the canvas so as to enlarge and display the input area.

The invention according to Claim 23 is the work processing program wherein the input/output screen editing function accepts the instruction for the change in the size of the canvas, and enlarges the grids in the canvas at the same magnification as that of the size of the canvas to be changed so as to enlarge and display the input area.

The size of the input area is changed, and further the size of the canvas is changed like the inventions so that the input area may be enlarged and displayed. For example, like the inventions of claims 14 and 22, the end of the canvas is dragged, so that the size of an arbitrary grid (for example, the endmost grind) in the canvas according to the dragging, and size of the input area is changed according to the grids. Like the inventions of claims 15 and 23, the size of the grids in the canvas is changed at the same magnification as that of the canvas whose size is changed, so that size of the input area can be changed according to the grid. In such a manner, the input area is enlarged and displayed according to the grids. Such enlargement and display of the input area occasionally enable all characters and an entire text which cannot be seen to be seen.

According to the present invention, the objects on the input/output screen can be created with them being related with the grids. For this reason, the size of the input area can be changed according to the number and the size (font size) of characters input onto the input area.

### BRIEF DESCRIPTION OF THE DRAWINGS

FIG. 1 is a system constitutional diagram illustrating one example of a constitution of an input/output screen creating system according to the present invention;

FIG. 2 is a system constitutional diagram illustrating one example of a work processing system according to the present invention;

FIG. 3 is a flowchart illustrating one example of a flow of a process when an input/output screen is created by the input/output screen creating system;

FIG. 4 is a flowchart illustrating one example of a process when the size of characters on the input/output screen is changed by the work processing system in which the created input/output screen is stored;

FIG. 5 is a flowchart illustrating one example of a flow of a process when the number of characters on the input/output screen exceeds in the work processing system in which the created input/output screen is stored;

FIG. 6 is a diagram illustrating one example of an initial form;

FIG. 7 is a diagram illustrating one example of the input/output screen;

FIG. 8 is a diagram illustrating one example of the form after a canvas is arranged;

FIG. 9 is a diagram illustrating one example of the form when grids are superposed and arranged on the canvas;

FIG. 10 is a conceptual diagram illustrating the relationship among the canvas, the grids, units and objects;

FIG. 11 is a diagram illustrating one example where five display areas and five input areas are arranged on the canvas;

FIG. 12 is a diagram illustrating one example where names of the display areas of the objects are changed;

FIG. 13 is a diagram illustrating the input/output screen in which the input/output screen of FIG. 12 is stored;

FIG. 14 is a diagram illustrating the input/output screen when the one grid of the input/output screen in FIG. 13 is changed from 9 points into 24 points;

FIG. 15 is a diagram illustrating a conventional input/output screen when the size of characters is changed;

FIG. 16 is a diagram illustrating the input/output screen when the size of the grids on the input/output screen in FIG. 13 is changed;

FIG. 17 is a diagram illustrating the case where characters are input into the object of the input area; and

FIG. 18 is a diagram illustrating the input/output screen including the object of the input area after the object in the input area of FIG. 17 is automatically enlarged and displayed.

### DESCRIPTION OF THE PREFERRED EMBODIMENTS

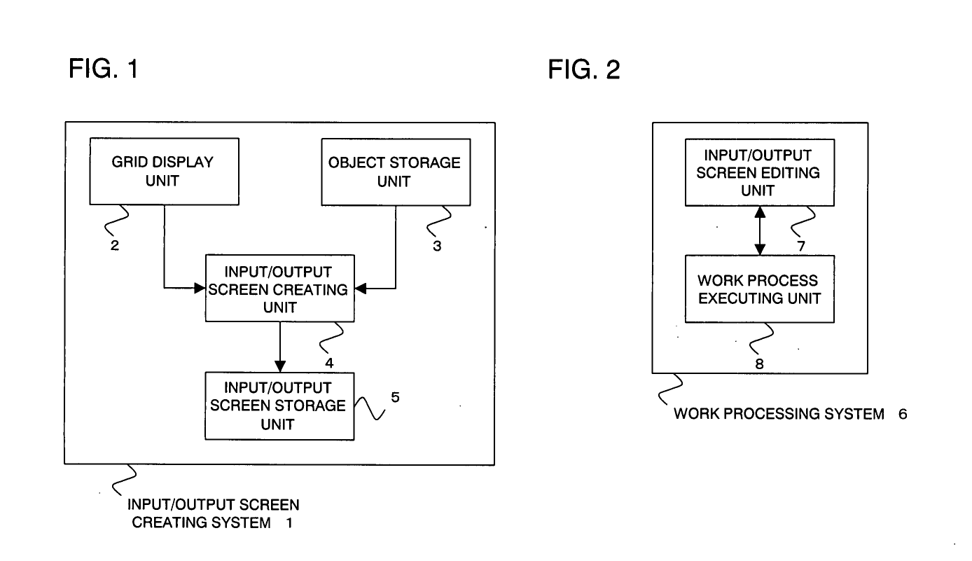

One example of a constitution of an input/output screen creating system 1 which creates an input/output screen to be used in a work processing system 6 is shown in the system constitutional diagram of FIG. 1. The input/output screen creating system 1 has an input/output screen creating section 4, a grid display section 2, an object storage section 3, and an input/output screen storage section 5.

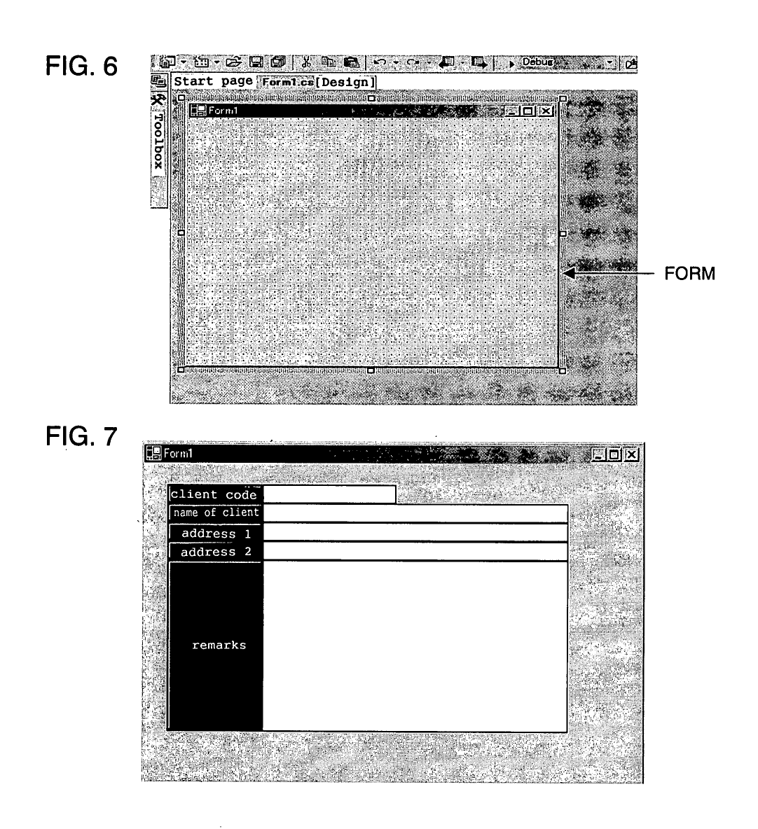

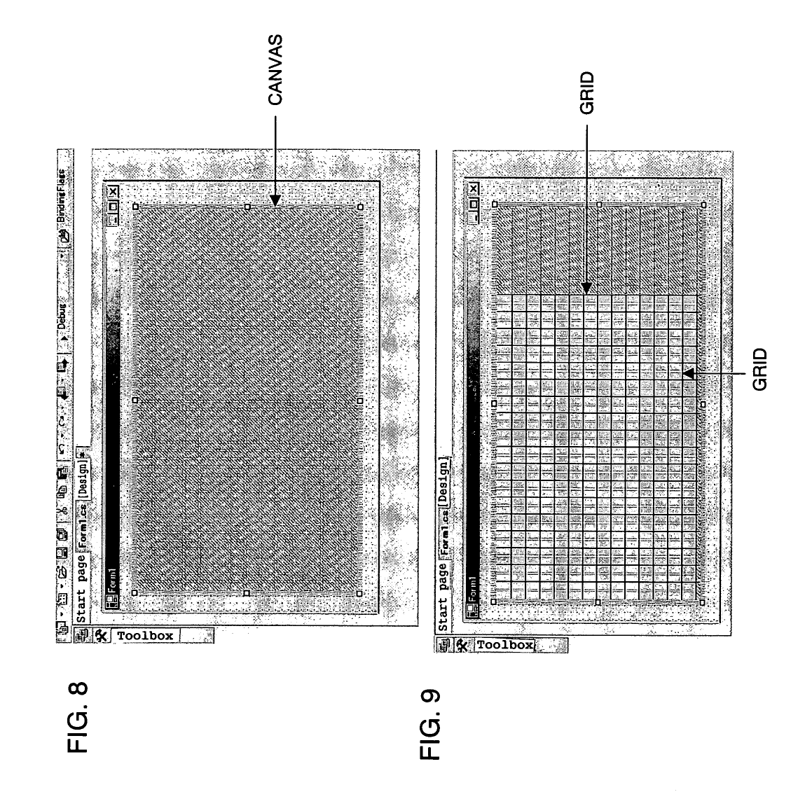

The input/output screen creating unit 4 is a unit that displays an area for creating and editing an input/output screen (form) on a computer terminal on which the input/output screen creating system 1 is actuated, and accepts inputs for creating and editing the input/output screen on the area. That is to say, the input/output screen creating unit 4 receives information on the input/output screen about objects or the like input onto the form by a programmer, and the input/output screen storage unit 5, mentioned later, stores the information therein. FIG. 6 shows an initial input/output screen of the form. Grids and objects, mentioned later, are pasted onto the form, so that an input/output screen shown in FIG. 7 is created. The input/output screen creating unit 4 arranges a job area for creating and editing the input/output screen as a canvas on the form, and accepts the inputs for the creating and editing the input/output screen. FIG. 8 is a diagram illustrating one example of the form after the canvas is arranged.

The grid display unit 2 is a unit that superposes and arranges squares (grids) with predetermined vertical and lateral sizes on the canvas of the form displayed on the computer terminal by the input/output screen creating unit 4. The size of one grid is set as a size of one-byte or two-byte character, number or symbol (hereinafter, character). The form when the grids are superposed and arranged on the canvas is shown in FIG. 9. In some occasions, a minimum or maximum rectangular area on which an object can be arranged may be set on the grids, and this rectangular unit is called a unit. The provision of such a unit can impose restrictions on the creation of an object whose size is equal to or more or less than a certain size. It is preferable that the size of the unit is normally one grid.

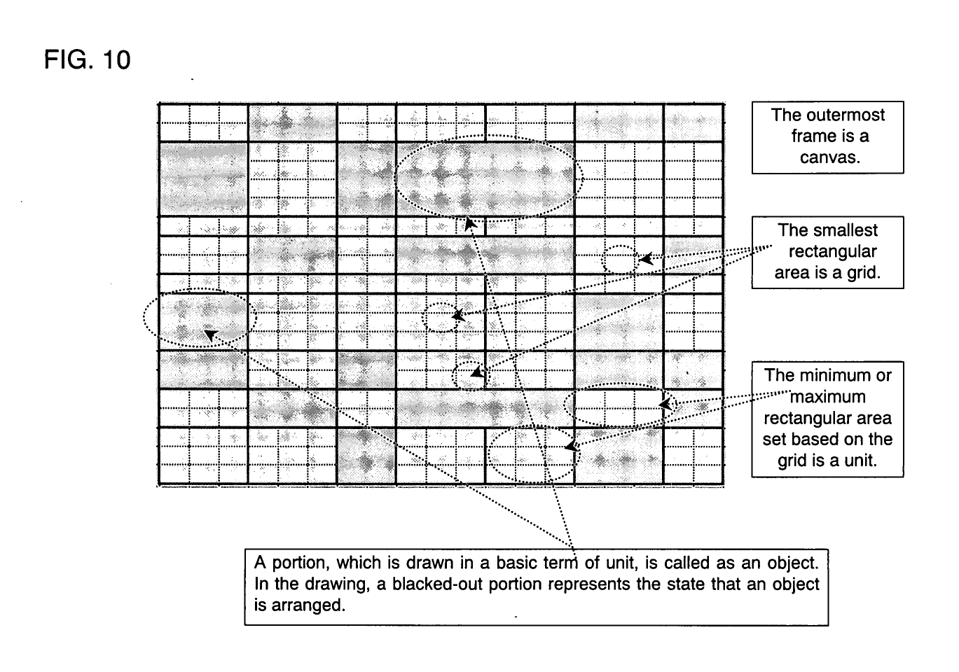

FIG. 10 shows the relationship among the canvas, the grids, the units, and the objects. The canvas is arranged in the form, and is a job area on the input/output screen. The canvas is separated by squares with certain sizes, and one square becomes a grid. The minimum or maximum rectangular area (rectangular area represented by the grids) for arranging an object is a unit, and an object is arranged according to the unit. The size of the unit becomes constant in a line (a vertical direction of the grids) and a rank (a lateral direction of the grids), but the sizes in the line and rank do not necessarily have to be constant, and thus the size can be changed in terms of the grid and the unit. The canvas does not have to be arranged on the form, and the form may be displayed as the canvas.

The object storage unit 3 indicates a character input area, a display area, a pull-down menu, buttons, and the like displayed on the input/output screen to be used in the work processing system 6. In FIG. 7 “client code”, “name of client”, “address 1”, “address 2”, and “remarks” are described as display areas, and character input areas are provided to the right sides of the display areas, respectively. A user of the work processing system 6 can input characters onto the character input areas.

The input/output screen storage unit 5 is a unit that stores the input/output screen created and edited by the input/output screen creating unit 4 therein. The positions of the objects on the grids on the input/output screen are stored as coordinates. Preferably, the coordinates are such that the upper left corner of the grids is an original point, the right side (x coordinate) and the down side (y coordinate) are regular directions. At the time of the storage, the coordinates are stored in a storage unit such as a hard disc or a memory on the computer terminal on which the input/output screen creating system 1 is actuated.

The input/output screen, which is created and edited by the input/output screen creating system 1 having the above constitution and is stored in the input/output screen storage unit 5, is used in the work processing system 6. That is to say, the input/output screen which is created and edited by the input/output screen creating system 1 is stored as a part of the work processing system 6, and is used when the work processing system 6 is operated.

The work processing system 6 has a job process executing unit 8 and an input/output screen editing unit 7. FIG. 2 is a system constitutional diagram of the work processing system 6.

The work process executing unit 8 is a unit that stores the input/output screens created by the input/output screen creating system 1 therein, and executes a financial accounting process, a payroll calculating process, a sales management process, a purchase management process, a stock management process, a tax filing process, a capital assets management process, a cost control process, a client management process, a human resource management process, an electronic banking process, an expense payment process, a travel and transportation expense calculating process, a bill management process, a picking process, a purchase orders management process, a credit reconcilement process, a budget management process, a cash schedule management process, an in-company application process, an attendance management process, a consolidated accounting process, a supplies management process, a credit and debt management process, and the like. At the time of executing these processes, the input/output screen is displayed on a computer terminal (user terminal) for a user of the work processing system 6 according to a data input request or the like from the user.

The input/output screen editing unit 7 is a unit that edits the input/output screens which are stored in the work process executing unit 8 and is created by the input/output screen creating system 1. It, for example, changes the size of an input area according to the number of and the size of characters (font size) to be input into the input area on the input/output screen.

When, for example, the size of the input area on the input/output screen occupies 5 grids (in the case where a two-byte character is set as one grid), if the sixth and thereinafter characters are input, the input area is widened by certain grids (for example, one grid).

When the size of one grid in the input area on the input/output screen is set to 9 points, if the font of characters to be input is changed from 9 points into 24 points, the size of one grid related with the input area is automatically changed into 24 points.

When the size of the canvas on which the input area is displayed is changed, the size of an arbitrary grid in the canvas is changed, so that the size of the input area may be changed according to the grid. For example, when the user drags the end of the canvas so as to change the vertical and lateral sizes of the canvas, the user may change the vertical and lateral sizes of the arbitrary grid in the canvas cooperatively so that the input area can be enlarged and displayed.

Further, when the size of the canvas on which the input area is displayed is changed, the size of the grids in the canvas may be changed at the same magnification as that of the size of the canvas to be changed, so that the size of the input area can be changed according to the grid. For example, when the user drags the end of the canvas so as to increase the size of the canvas by half, the user changes the grids in the canvas by half cooperatively, so that the input area can be enlarged and displayed.

The enlarged display of the input area enables an area which is not seen all the while to be displayed.

As a result, the size of the input area can be changed according to the number and the size of characters. Since the input area is not simply enlarged but its size is increased according to the grids, the size of the input area can be entirely aligned according to each grid.

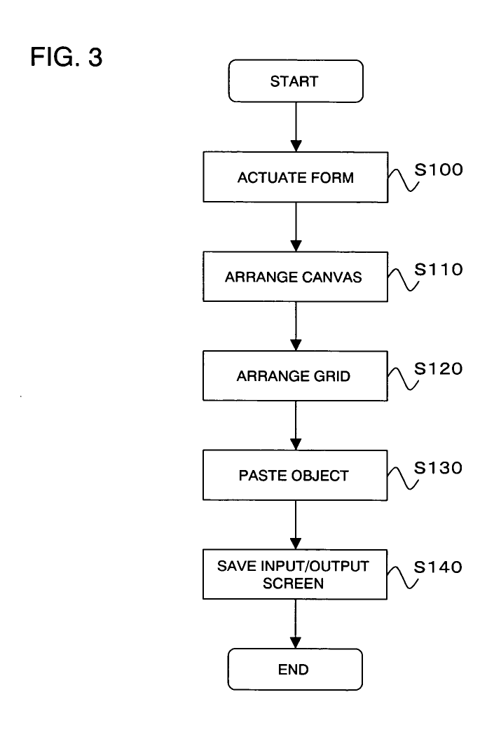

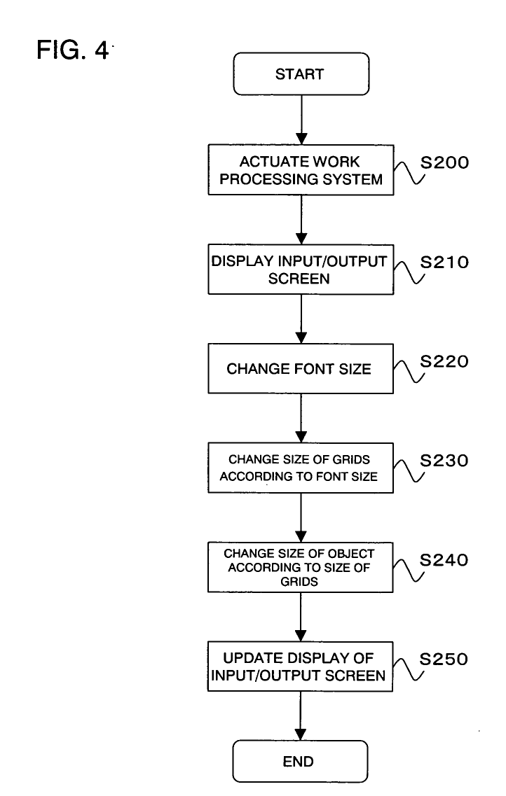

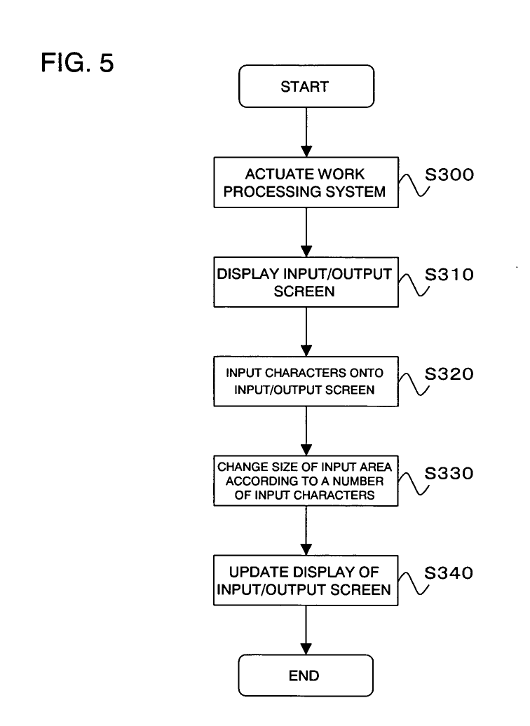

Examples of the flow of the process according to the present invention are explained with reference to flowcharts in FIGS. 3 to 5, and flowcharts in FIGS. 1 and 2.

The process when the input/output screen to be used in the work processing system 6 is created is explained below.

A programmer who creates the input/output screens to be used in the work processing system 6 performs a predetermined operation on the computer terminal in which the input/output screen creating system 1 is actuated so as to execute an input for actuating the form. The input/output screen creating unit 4 accepts the input, and displays the form on the computer terminal (S100). FIG. 6 is a diagram illustrating the state that the form is displayed on the computer terminal.

After the form is displayed, the programmer arranges a canvas on the form (S110). That is to say, the input/output screen creating unit 4 accepts an instruction about an arrangement position of the canvas, and the canvas is arranged and displayed on the form. FIG. 8 is a diagram illustrating the state that the canvas is arranged on the form.

After the canvas is arranged, the programmer superposes and arranges the grids on the canvas. That is to say, the grid display unit 2 accepts an instruction in arranging the grids, and superposes and displays the grids on the canvas (S120). At this time, the size of one grid is set as a certain unit (a certain font per one-byte or two-byte character). FIG. 9 is a diagram illustrating the state that the grids are arranged on the canvas. In this embodiment, the size of one grids is set as 9 points.

When the grids are arranged on the canvas, the grids may be arranged on the entire canvas, and as shown in FIG. 9, the grids may be arranged on a part of the canvas. When the unit is not set as one grid, the input/output screen creating unit 4 may accept an instruction about how many grids the unit corresponds to. When, for example, the minimum size of an object is desired to be edited in a term of two grids, if the programmer inputs one unit as two grids, the input/output screen creating unit 4 accepts the input, so that the size of the object or the like can be set to the size of one unit (2 grids). This specification, for convenience, explains the case where one unit corresponds to one grid, but the invention is not limited to this.

After the grids are superposed and arranged on the canvas, the programmer selects an object to be pasted to the canvas. The input/output screen creating unit 4 reads the selected object from the object storage unit 3, and relates the read object with the coordinates of the grids so as to paste it onto the canvas indicated by the programmer (S130). The object can be arranged for each unit. For example as shown in FIG. 7, when the input/output screen for client information is created, five objects as the display areas and five objects as the input areas are pasted onto the canvas in the state of FIG. 9. For example, the display area having the name “cell” is arranged so that the coordinate of the upper left of the the object (cell) (x,y)=(0,0), and the coordinate of lower right (x,y)=(5,1).

An object (cell 2) is arranged so that the coordinate of its upper left in the input area (x,y)=(5,0), and the coordinate of the lower right (x,y)=(12,1). An object (cell 3) is arranged so that the coordinate of its upper left in the display area is (x,y)=(0,1), and the coordinate of its lower right is (x,y)=(5,2). An object (cell 4) is arranged so that the coordinate of its upper left in the input area is (x,y)=(5,1), and the coordinate of its lower right is (x,y)=(21,2). An object (cell 5) is arranged so that the coordinate of its upper left in the display area is (x,y)=(0.2), and the coordinate of its lower right is (x,y)=(5,3). An object (cell 6) is arranged so that the coordinate of its upper left in the input area is (x,y)=(5,2), and the coordinate of its lower right is (21,3). An object (cell 7) is arranged so that the coordinate of its upper left in the display area is (x,y)=(0,3), and the coordinate of its lower right is (x,y)=(5,4). An object (cell 8) is arranged so that the coordinate of its upper left in the input area is (x,y)=(5,3), and the coordinate of its lower right is (x,y)=(21,4). An object (cell 9) is arranged so that the coordinate of its upper left in the display area is (x,y)=(0,4), and the coordinate of its lower right is (x,y)=(5,13). An object (cell 10) is arranged so that the coordinate of its upper left in the input area is (x,y)=(5,4), and the coordinate of its lower right is (x,y)=(21,13).

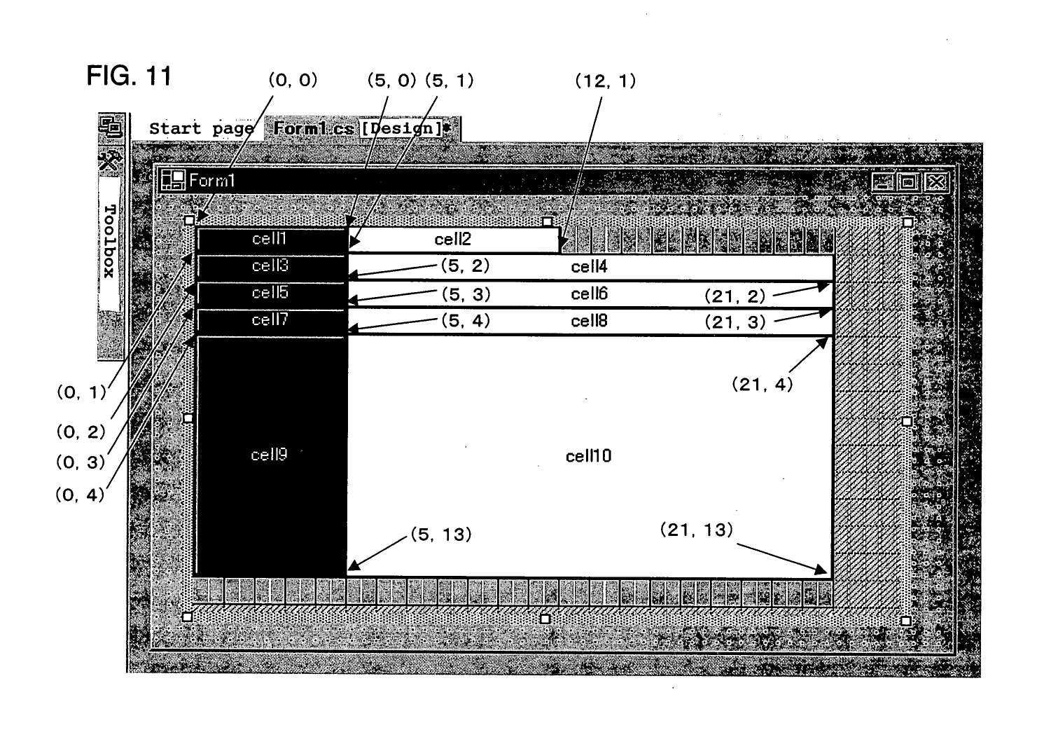

FIG. 11 is a diagram illustrating the state that the five display areas (cell, cell 3, cell 5, cell 7, and cell 9) and the five input areas (cell 2, cell 4, cell 6, cell 8, and cell 10) are arranged on the canvas.

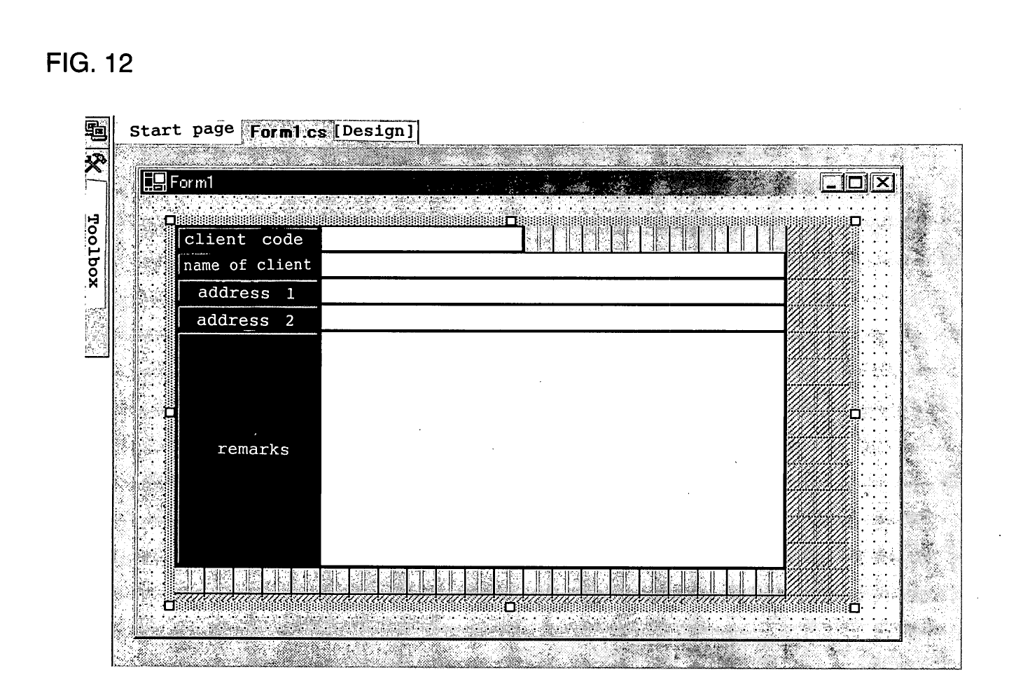

The objects are arranged so as to be related with the grids displayed on the canvas in a superposed manner, so that the objects can be represented by the x coordinate and the y coordinate on the grids. After the objects are arranged, as for the display areas of the objects, “client code” is displayed on the cell 1, “name of client” is displayed on the cell 3, “address 1” is displayed on the cell 5, “address 2” is displayed on the cell 7, and “remarks” is displayed on the cell 9. As a result, the state in FIG. 12 is obtained.

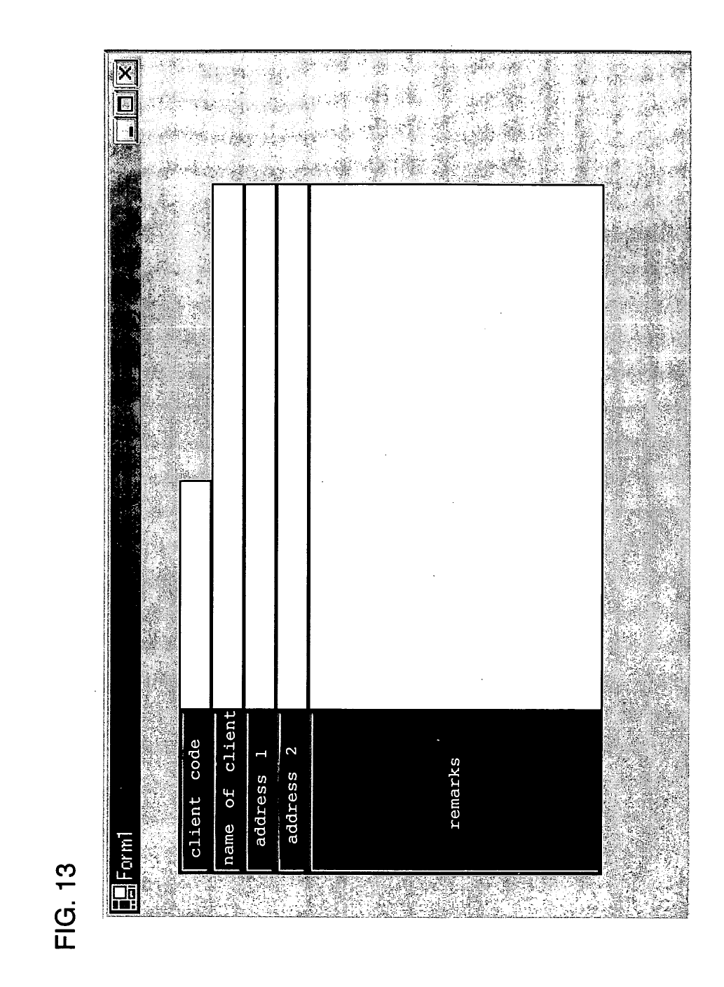

When the programmer performs a predetermined operation for saving the input/output screen created in such a manner, the input/output screen creating unit 4 accepts the instruction, the input/output screen storage unit 5 stores the input/output screen created on the canvas therein (S140). That is to say, when the input/output screen in FIG. 12 is saved, the input/output screen is as shown in FIG. 13.

The input/output screen stored in the input/output screen storage unit 5 is stored in the work process executing unit 8 of the work processing system 6, so that when the work processing system 6 executes processes, the input/output screen can be used. The occasion where the input/output screen is used in the work processing system 6 is explained below. The occasion where the font size of characters to be displayed on the input/outputs screen is changed is explained.

The user of the work processing system 6 (a person in charge of the work in a company) performs a predetermined operation on a computer terminal (user terminal) on which the work processing system 6 is operated, so that the work process executing unit 8 actuates the work processing system 6 (S200). After the work processing system 6 is operated, when the user selects data input into the work processing system 6, the work process executing unit 8 accepts the selection. The work process executing unit 8 displays the input/output screen created by the input/output screen creating system 1 on the user terminal (S210). The work process executing unit 8 displays the input/output screen shown in FIG. 13, for example, on the user terminal.

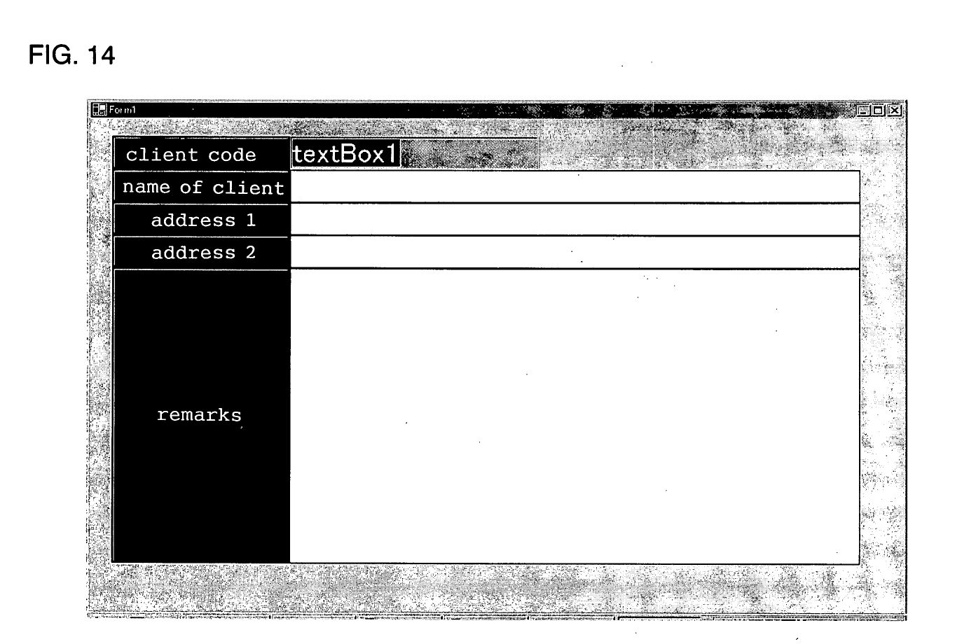

When the user feels that the characters are small with respect to the input/output screen, the user performs a predetermined operation so as to change the font size (S220). The input/output screen editing unit 7 accepts an input of the changed font size, and changes the font size of the grids on the input/output screen (S230 and S240). When, for example, the size of the grids on the input/output screen in FIG. 13 is 9 points, the user changes the size into 24 points. As a result, the input/output screen editing unit 7 accepts an input of the change into 24 points, and changes the size of the grids on the input/output screen from 9 points into 24 points so as to display the changed grids (S250). FIG. 14 is a diagram illustrating the input/output screen when one grid on the input/output screen of FIG. 13 is changed from 9 points into 24 points.

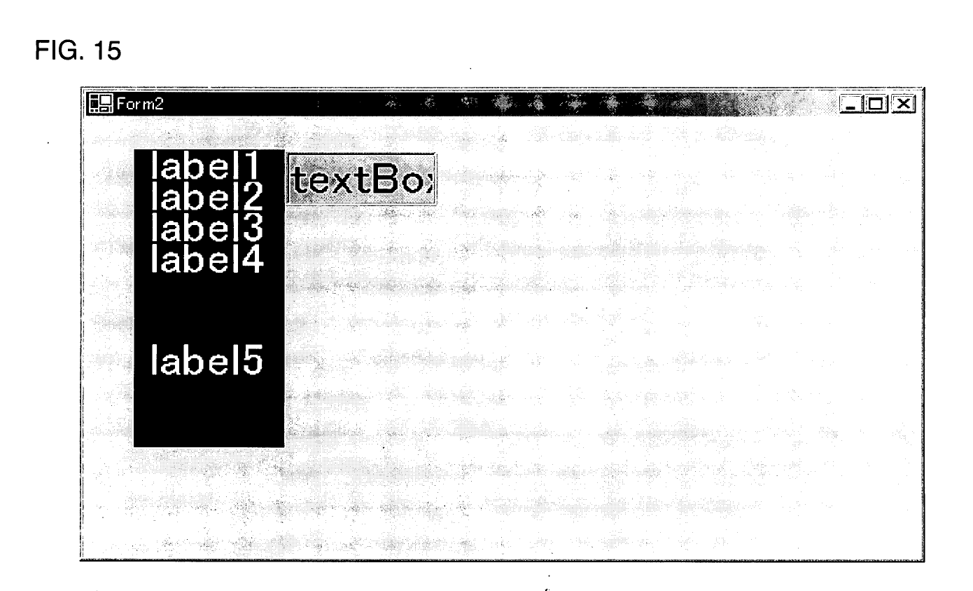

When the size of characters to be displayed on a conventional input/output screen is changed, only the size of characters to be displayed as objects is changed. This is because since the objects are arranged directly on the form, the positions of the objects are not related with the size of the characters, and only the size of the characters displayed on the objects is changed, and thus the size of the objects cannot be changed. The left, right, top and bottom of the characters displayed on the objects, therefore, chip off to be displayed in some cases. For example, characters are displayed as shown in FIG. 15.

Like the present invention, however, the size of the grids is set as the size of characters (font size), and the objects on the input/output screen are arranged in positions according to the coordinates on the grids. As a result, when the font size is changed, the size of the grids is changed (S230), and the size of the objects having the coordinates on the grids is changed according to the size of the grids (S240). For this reason, as shown in FIG. 14, the size of characters can be changed without changing the positional relationship among the objects (S250).

The positions of the objects on the input/output screen, therefore, are represented by the coordinates of the grids, and thus even if the size of characters are changed from 9 points into 24 points, for example, the coordinates do not change.

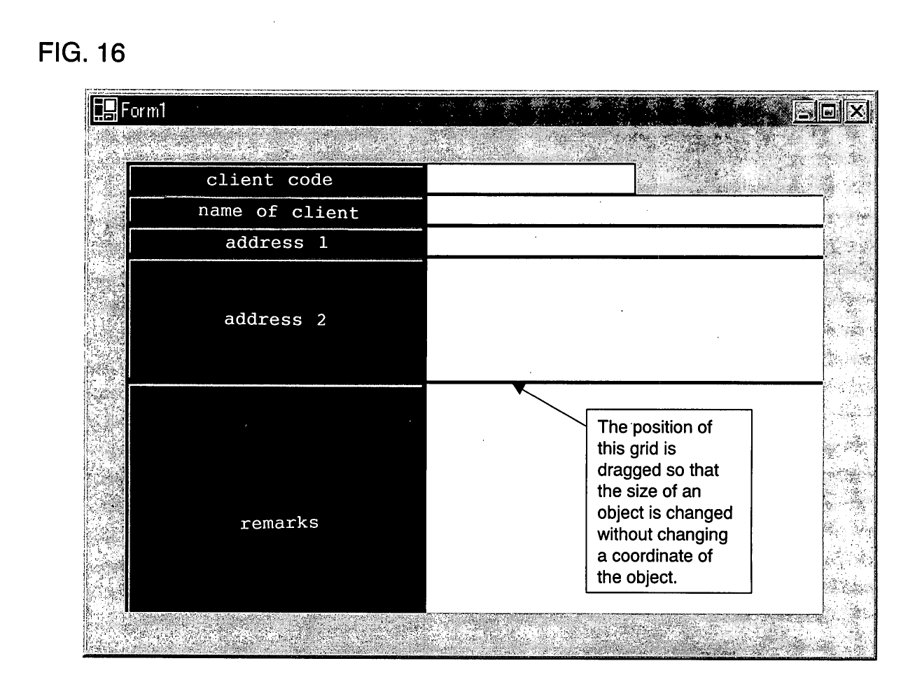

Since the positions of the objects are represented by the grids, when, for example, an input for changing the size of a specified grid is executed, the input/output screen editing unit 7 which accepts the input can change the size of the grid. When, for example, the size of the object “address 2” and the size of the related input area on the input/output screen in FIG. 13 are changed, the sizes of the “address 2” and the input area are dragged by an input device such as a mouse or a keyboard so that the input/output screen editing unit 7 accepts the input. As a result, the size of “address 2” and the size of the grids on the input area can be changed. FIG. 16 is a diagram illustrating the input/output screen when the size of the grids is changed in such a manner.

When the user drags the canvas having the input area using the input device such as the mouse or the keyboard, the input/output screen editing unit 7 accepts the input, so that the size of arbitrary grid in the canvas (preferably the end of the canvas) is changed. As a result, the size of the grids in the input area is changed. According to the change in the size of the canvas, therefore, the size of the input area can be also changed.

When the size of the canvas is changed, the vertical size and/or the lateral size of an arbitrary grid in the canvas may be changed cooperatively with the vertical size and/or the lateral size of the canvas, or the magnification of the size of the grid in the canvas may be changed according to the magnification of the changed size of the canvas.

In the case where characters are input onto the input/output screen, the process when the input area is enlarged to be displayed according to the number of the characters is explained below.

The user of the work processing system 6 (a person of a company in charge of the work) performs a predetermined operation on the user terminal, the work process executing unit 8 actuates the work processing system 6 (S300). After the work processing system 6 is performed, when the user selects data input into the work processing system 6, the work process executing unit 8 accepts the selection. The work process executing unit 8 displays the input/output screen created by the input/output screen creating system 1 on the user terminal (S310). The work process executing unit 8 displays the input/output screen shown in FIG. 13, for example, on the user terminal.

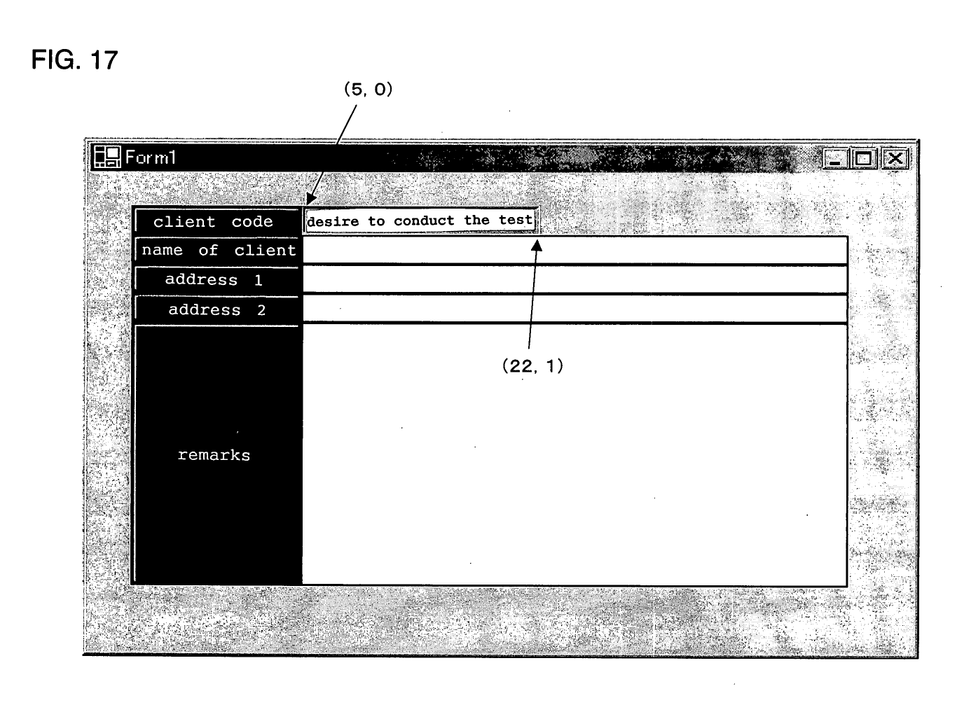

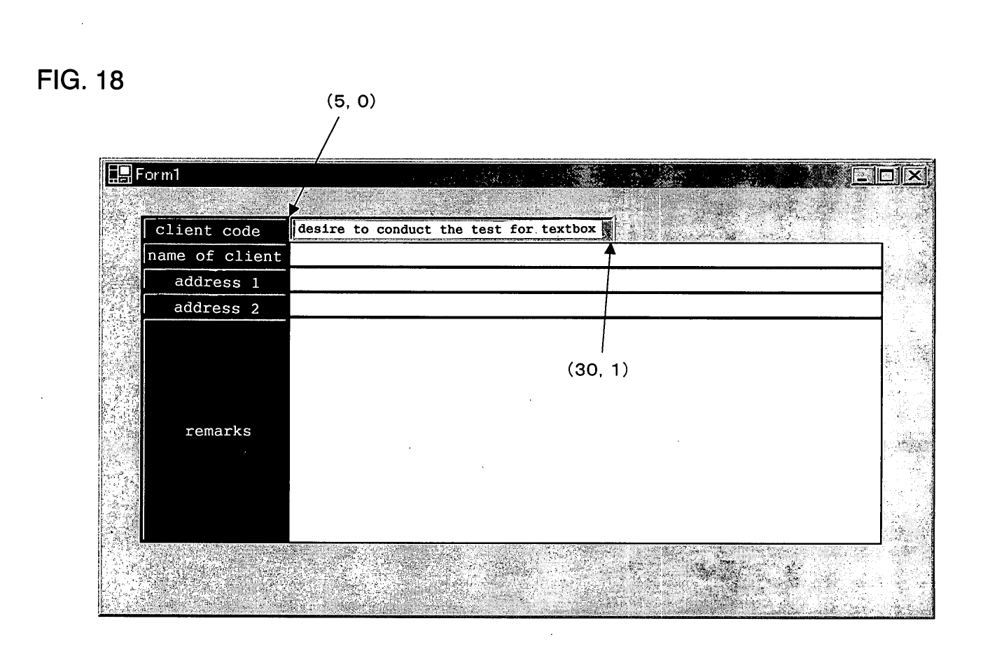

When characters whose number accords with the size of the input area are input onto the input/output screen (S320), the input/output screen editing unit 7 changes the coordinate of the object as the input area, so as to change the input area (S330). The changed input area is displayed on the input/output screen (S340). For example as shown in FIG. 17, characters are input into the object in the input area related with the client code, and when the number of characters capable of being input onto the input area is 17, the eighteenth and thereinafter characters cannot be displayed. The number of characters for 1 line capable of being input can be calculated by subtracting the x coordinate of the upper left of the object from the x coordinate of the lower right of the object. The number of lines can be calculated by subtracting the y coordinate of the upper right of the object from the y coordinate of the lower right of the object. The calculated number of character for 1 line is multiplied by the calculated number of the lines so that the number of characters in the input area can be calculated.

When, for example, the coordinate of the upper left of the object in the input area related with the client code in FIG. 17 is (5,0) and the coordinate of the lower right is (22,1), the number of characters capable of being input onto the input area becomes 17 according to (22−5)×(1−0). At the time when “desire to conduct the test” is input, the number of characters becomes 17. For this reason, the input/output screen editing unit 7 changes the coordinate of the lower right in the input area at the time when the number reaches the number of characters capable of being input or when the number of characters reaches a predetermined ratio (for example, eight tenths) of the number of characters capable of being input, so as to shift the coordinate to the right. That is to say, the object is automatically enlarged and displayed. For example, the coordinate (22,1) is changed into the coordinate (30,1). As a result, a space for eight characters capable of being input can be further secured in the input area, and thus “for textBox” is input after “desire to conduct the test”, so that all the characters can be displayed. One example of this state is shown in FIG. 18.

The coordinate of the grids of the object is not changed, but the size of the grids including the coordinate of the lower right of the object may be enlarged, so that the object is automatically enlarged to be displayed.

Since the size of the input area on the conventional input/output screen is fixed, when the number of characters exceeds the number of characters capable of being input in the input area, the input characters are scrolled so that new input of characters is accepted. For this reason, in order to check input characters, it is necessary for the user to scroll characters every time of input. The object, however, is arranged on the coordinates on the grids, so that the object (input area) can be enlarged and displayed according to the number of input characters.

The work processing program into which the above process contents of the work processing system 6 are recorded is recorded in a recording medium such as CD or DVD, and this program is read into the computer terminal, so that the work processing system 6 may be realized. The work processing system 6 is downloaded from a predetermined server into the computer terminal via a network and is read into the computer terminal so as to be realized.

In this case, the work processing program has input/output screen data to be used in the work processing program created by the input/output screen creating system 1, and a function (module or a program, and same hereinafter) which operates the work process executing unit 8 on the computer terminal, and a function which operates the input/output screen editing unit 7 on the computer terminal. At this time, the computer terminal has a storage unit (a storage medium such as a memory, a cache, or a hard disc) that stores data therein, and a process arithmetic unit that executes the work processing program (an arithmetic unit such as a CPU or a register).

The recording medium into which the work processing program is recorded is set in the computer terminal of the user, and the work processing program is read from the recording medium into the computer terminal so that the input/output screen data are stored in the storage unit of the computer terminal. The functions which operate the job process executing unit 8 and the input/output screen editing unit 7 are read into the process arithmetic unit of the computer terminal. The work process executing unit 8 read into the process arithmetic unit receives an input operation from the computer terminal so as to display the input/output screen on the computer terminal based on the input/output screen data stored in the storage unit.

When the user changes the size of characters similarly to the above example, the input/output screen editing unit 7 read into the process arithmetic unit receives the input of the changed size of the characters. The input/output screen editing unit 7 changes the size of the grids similarly to the above example so as to update the display of the input/output screen.

When the user inputs characters whose number exceeds the number of characters capable of being input onto the input area as the object, the input/output screen editing unit 7 read into the process arithmetic unit updates the coordinate of the grid in the input area similarly to the above example. In another manner, the input/output screen editing unit 7 changes the size of the grids in the input area, so as to update the display of the input/output screen in a state that the input area is automatically enlarged and displayed and the number of the characters capable of being input is increased.

Also when the work processing program is downloaded from the network into the computer terminal, the process is executed similarly to the case where the program in the recording medium into which the work processing program is recorded is executed on the computer terminal.

The respective functions of the present invention are only classified logically, and they may form the same area physically or factually.

In order to carry out the present invention, naturally the storage medium in which systems of software which realize the functions of the embodiment are stored is supplied to the system, and the computer in this system reads the systems stored in the storage medium and executes them so as to be realized.

In this case, the systems themselves read from the storage medium realize the functions of the embodiment, and the storage medium in which the systems are stored composes the present invention naturally.

As the storage medium for supplying the systems, for example, a magnetic disc, a hard disc, an optical disc, a magneto-optical disc, a magnetic tape, a non-volatile memory card, and the like can be used.

The systems read by the computer are operated, so that the functions of the embodiment are realized. Further, needless to say, an operating system or the like which operates on the computer executes some or all the actual processes based on instructions from the systems, and the functions of the embodiment are realized by the processes.

The systems read from the storage medium are written into a non-volatile or volatile storage unit provided to a function enhancing board inserted into the computer or a function enhancing unit connected with the computer. An arithmetic unit or the like provided to the function enhancing board or the function enhancing unit executes some or all the actual processes based on instructions from the systems. The functions of the embodiment are realized by these processes.

According to the present invention, objects on the input/output screen are created with them being related with the grids, and the size of the input area can be changed according to the number and the size of characters (font size) input into the input area.

What is claimed is:

1. An input/output screen creating system that creates an input/output screen to be used in a work processing system, comprising:
an object storage unit that stores a plurality of objects capable of being arranged on the input/output screen;
an input/output screen creating unit that displays a form for creating and editing the input/output screen and accepts an input for arranging the objects stored in the object storage unit on the form;
a grid display unit that superposes and arranges grids having the size for a two-byte or one-byte character on a canvas to be a job area of the input/output screen provided on the form; and
an input/output screen storage unit that stores the input/output screen having the objects related with the grids and arranged.

2. The input/output screen creating system according to claim 1, wherein the input/output screen creating unit accepts an input of a rectangular area as a unit having an arbitrary size capable of being accordance with the size of the objects, and accepts an input of the arrangement of the objects on the canvas in a term of unit.

3. The input/output screen creating system according to claim 1, wherein the work processing system is any one or more of a financial accounting system, a payroll calculating system, a sales management system, a purchase management system, a stock management system, a tax filing system, a capital assets management system, a cost control system, a client management system, a human resource management system, an electronic banking system, an expense payment system, a travel and transportation expense calculating system, a bill management system, a picking system, a purchase orders management system, a credit reconcilement system, a budget management system, a cash schedule management system, an in-company application system, an attendance management system, a consolidated accounting system, a supplies management system, and a credit and debt management system.

4. An input/output screen creating method of creating an input/output screen to be used in a work processing system on a computer terminal, comprising:
the step of displaying a form for creating and editing the input/output screen on a display device of the computer terminal;
the step of arranging a canvas to be a job area of the input/output screen on the form;
the step of superposing and arranging grids having the size for a two-byte or one-byte character on the canvas; and
the step of arranging objects to be arranged on the input/output screen with them being related with coordinates of the grids.

5. An input/output screen creating method of creating an input/output screen to be used in a work processing system on a computer terminal, comprising:
the step of simultaneously displaying a form for creating and editing the input/output screen and a canvas as a job area of the input/output screen on a display device of the computer terminal so that they have the same size;
the step of superposing and arranging grids having the size for a two-byte or one-byte character on the canvas; and
the step of arranging objects on the input/output screen with them being related with coordinates of the grids.

6. An input/output screen creating method of creating an input/output screen to be used in a work processing system on a computer terminal, comprising:
the step of displaying a form for creating and editing the input/output screen as a canvas to be a job area of the input/output screen on a display device of the computer terminal;
the step of superposing and arranging grids having the size for a two-byte or one-byte character on the canvas; and
the step of arranging objects on the input/output screen with them being related with coordinates of the grids.

7. The input/output screen creating method according to any one of claims 4 to 6, further comprising the step of setting a rectangular area having an arbitrary size capable of being in accordance with the size of the object as a unit after arranging the superposing and arranging the grids on the canvas.

8. A work processing system having an input/output screen on which an object is arranged with it being related with grids having the size for a two-byte or one-byte character, comprising:
a work process executing unit that executes a process of the work processing system and displays the input/output screen; and
an input/output screen editing unit that changes the size of an input area according to the number or a size of characters input into the object in the input area on the input/output screen.

9. The work processing system according to claim 8, wherein the input/output screen editing unit calculates the number of characters capable of being input into the input area based on the grids, compares the number of characters capable of being input with the number of characters accepted by the work process executing unit, and when the number of input characters exceeds a predetermined number of characters, enlarges and displays the input area.

10. The work processing system according to claim 9, wherein the input/output screen editing unit changes the coordinates of the grid related with the input area so as to enlarge and display the input area.

11. The work processing system according to claim 9, wherein the input/output screen editing unit changes the size of the grids in the input area so as to enlarge and display the input area.

12. The work processing system according to claim 8, wherein the input/output screen editing unit accepts an instruction for a change in the size of characters to be displayed on the input/output screen and changes the size of the grids so as to change sizes of characters and the object to be displayed on the input/output screen.

13. The work processing system according to claim 8, wherein the input/output screen editing unit accepts an instruction for a change in the size of the canvas and changes the size of the grids in the canvas so as to enlarge and display the input area.

14. The work processing system according to claim 13, wherein the input/output screen editing unit accepts the instruction for the change in the size of the canvas, changes a vertical size and/or a lateral size of an arbitrary grid in the canvas cooperatively with the instruction for the change in a vertical and/or a lateral size of the canvas so as to enlarge and display the input area.

15. The work processing system according to claim 13, wherein the input/output screen editing unit accepts the instruction for the change in the size of the canvas, and enlarges the grids in the canvas at the same magnification as that of the size of the canvas to be changed so as to enlarge and display the input area.

16. A work processing program that is executed on a computer terminal having a storage unit which stores data therein and a process arithmetic unit which executes a process of a program, comprising:
data about an input/output screen read into the storage unit;
a work process executing function that is read into the process arithmetic unit; and
an input/output screen editing unit that is read into the process arithmetic unit,
wherein the data about the input/output screen are objects which are arranged on the input/output screen so as to be related with grids having the size for a two-byte or one-byte character,
the work process executing function displays the input/output screen on the computer terminal based on the data bout the input/output screen stored in the storage unit and executes the work process,
the input/output screen editing function changes the size of the input area according to the number or the size of characters input into the object in the input area on the input/output screen.

17. The work processing program according to claim 16, wherein the input/output screen editing function calculates the number of characters capable of being input into the input area based on the grids, compares the number of characters capable of being input with the number of characters input by the work process executing function, and when the number of the input characters exceeds a predetermined number of characters, enlarges and displays the input area on the computer terminal.

18. The work processing program according to claim 17, wherein the input/output screen editing function changes coordinates of the grids related with the input area so as to enlarge and display the input area.

19. The work processing program according to claim 17, wherein the input/output screen editing function changes the size of the grids in the input area so as to enlarge and display the input area.

20. The work processing program according to claim 16, wherein the input/output screen editing function accepts an instruction for a change in the size of characters to be displayed on the input/output screen, and changes the size of the grids so as to change sizes of characters and objects to be displayed on the input/output screen.

21. The work processing program according to claim 16, wherein the input/output screen editing function accepts an instruction for a change in the size of the canvas, and changes the size of the grids in the canvas so as to enlarge dan display the input area.

22. The work processing program according to claim 21, wherein the input/output screen editing function accepts the instruction for the change in the size of the canvas, and changes a vertical size and/or a lateral size of an arbitrary grid in the canvas cooperatively with the instruction for the change in a vertical size and/or a lateral size of the canvas so as to enlarge and display the input area.

23. The work processing program according to claim 21, wherein the input/output screen editing function accepts the instruction for the change in the size of the canvas, and enlarges the grids in the canvas at the same magnification as that of the size of the canvas to be changed so as to enlarge and display the input area.

24. A recording medium in which the work processing program according to any one of claims 16 to 23 is recorded.
